(19) United States
(12) Patent Application Publication
(10) Pub. No.: US 2020/0173506 A1
(43) Pub. Date: Jun. 4, 2020

(54) BRAKE DISK OF COMPOSITE MATERIAL AND MANUFACTURING METHOD THEREOF

(71) Applicants: HYUNDAI MOTOR COMPANY, SEOUL (KR); KIA MOTORS CORPORATION, SEOUL (KR); DACC CARBON, JEONJU-SI (KR)

(72) Inventors: Jae Hun Shim, Hwaseong-si (KR); Gab Bae Jeon, Hwaseong-si (KR); Joung Hee Lee, Hwaseong-si (KR); Dong Won Lim, Changwon-si (KR); Hong Sik Park, Jeonju-si (KR)

(21) Appl. No.: 16/374,413

(22) Filed: Apr. 3, 2019

(30) Foreign Application Priority Data
Dec. 4, 2018 (KR) 10-2018-0154129

(51) Int. Cl. F16D 65/12; C04B 35/83; C04B 35/622

(52) U.S. Cl. CPC F16D 65/121; F16D 2065/132; C04B 35/62204; C04B 35/83

(57) ABSTRACT

A brake disk of a composite material includes a load part and friction parts coupled to opposing sides of the load part, wherein the load part includes a reinforcing part formed of a carbon-carbon fiber (C-CF) material and a matrix part formed of a material including silicon carbide (SiC) and covering the reinforcing part, and a weight ratio of the reinforcing part is equal to or lower than a weight ratio of the matrix part in the load part.

### CROSS REFERENCE TO RELATED APPLICATION

The present application claims priority to Korean Patent Application No. 10-2018-0154129, filed on Dec. 4, 2018, the entire contents of which is incorporated herein for all purposes by this reference.

### BACKGROUND

### 1. Technical Field

The present disclosure relates to a brake disk of a composite material and a manufacturing method thereof, and more particularly, to a brake disk of a composite material manufactured to include reinforcing fibers and ceramics, and a manufacturing method thereof.

### 2. Description of the Related Art

The contents described as the related art have been provided only to assist in understanding the background of the present disclosure and should not be considered as corresponding to the related art known to those having ordinary skill in the art.

Carbon ceramic brake disks are classified as drum type brake disks and disk type brake disks.

The disk type brake slows rotation of a disk by frictional contact between a surface of the disk and a pad to thus decelerate or stop a vehicle.

The disk type brake should be light in weight, have a high thermal shock resistance, high oxidation resistance, high wear resistance, high strength, and high friction coefficient. To this end, recently, a large number of disk-type carbon ceramic brake disks (hereinafter, referred to as “carbon ceramic brake disks”) are formed of carbon fiber-reinforced ceramic composite material.

The carbon fiber-reinforced ceramic composite material is a material having ceramics as a matrix and reinforced with carbon fibers. When a carbon ceramic brake disk is formed of the carbon fiber-reinforced ceramic composite material, the carbon ceramic brake disk may be light in weight, have a high thermal shock resistance, high oxidation resistance, high wear resistance, and high friction coefficient.

The carbon ceramic brake disk formed of the carbon fiber-reinforced ceramic composite material has a larger specific heat but smaller density than a cast iron brake disk. Therefore, a temperature of the disk is increased more rapidly than that of the cast iron brake disk due to the frictional contact between the surface of the disk and the pad during braking. Here, the carbon ceramic brake disk itself which may sufficiently withstand at high temperatures has no problems, but the pad, a hat part, and a caliper installed in the vicinity thereof are thermally deformed and deteriorated.

When the pad is thermally deformed and deteriorated, a variation width of the friction coefficient between the disk and the pad is increased and braking performance is not uniform.

When the hat part is thermally deformed and deteriorated, wheels and the hat part are not balanced, causing noise and vibration.

When the caliper is thermally deformed and deteriorates, the caliper cannot properly adhere the pad to the carbon ceramic brake disk, causing noise and vibration. Further, when the caliper is heated, a brake fluid for operating the caliper is boiled to rapidly degrade braking performance.

To solve these problems, the carbon ceramic brake disk is manufactured to be larger than the cast iron brake disk (the outer diameter is 1-inch larger), thus increasing the volume to prevent a rapid increase in temperature of the brake disk.

However, this causes the size of the brake disk to be different so the cast iron brake disk cannot be immediately replaced with the carbon ceramic brake disk until the vehicle is changed.

Therefore, there is a need for a new composite material capable of improving heat conductivity of the material itself, without increasing the size, to thus improve heat dissipation properties of the brake disk.

The foregoing is intended merely to aid in the understanding of the background of the present disclosure, and is not intended to mean that the present disclosure falls within the purview of the related art that is already known to those skilled in the art.

### SUMMARY

An object of the present disclosure is to provide a brake disk of a composite material having high heat dissipation properties and a manufacturing method thereof.

According to an embodiment of the present disclosure, a brake disk of a composite material, includes: a load part and friction parts coupled to opposing sides of the load part, wherein the load part includes a reinforcing part formed of a carbon-carbon fiber (C-CF) material and a matrix part formed of a material including silicon carbide (SiC) and covering the reinforcing part, and a weight ratio of the reinforcing part is equal to or lower than a weight ratio of the matrix part in the load part.

A weight ratio of the reinforcing part and the matrix part in the load part may be 0.4 to 1:1.

The reinforcing part may include a plurality of carbon fiber filaments and carbon particles covering the carbon fiber filaments.

According to another embodiment of the present disclosure, a method for manufacturing a brake disk of a composite material including a load part and friction parts coupled to opposing sides of the load part includes: a load part manufacturing operation of including a first impregnation process to impregnate a reinforcing part formed of a carbon-carbon fiber (C-CF) material with a resin, a carbonization process of carbonizing the resin-impregnated reinforcing part, and a second impregnation process of impregnating melted silicon (Si) to form a matrix part including silicon carbide (SiC); and a friction part manufacturing operation of forming the friction parts on opposing sides of the load part.

During the carbonization process, the impregnated resin may be heat-treated at 900 to 1000° C. to change the resin into carbon (C), and during the second impregnation process, pores formed as the resin is carbonized during the carbonization process may be impregnated with silicon (Si) heated to 1300° C. or higher.

During the first impregnation process, the reinforcing part may be impregnated with a mixture of a resin and silicon carbide.

During the load part manufacturing operation, after the first impregnation process is performed, the carbonization process and the second impregnation process may be repeatedly performed a plurality of times to form a matrix part covering the reinforcing part.

### BRIEF DESCRIPTION OF THE FIGURES

FIG. 1 is a view illustrating the entire structure of a brake disk of a composite material according to an embodiment of the present disclosure;

FIGS. 2 and 3 are views illustrating a structure of a load part of a prior art brake disk of a composite material;

FIG. 4 is a graph illustrating thermal conductivity and bending strength changed according to fractions of carbon fibers in the structure of the load part of a prior art brake disk of a composite material;

FIG. 5 is a view illustrating a structure of a load part of a brake disk of a composite material according to an embodiment of the present disclosure;

FIGS. 6A and 6B are views illustrating a state of a carbon-carbon fiber (C-CF) of a brake disk of a composite material according to an embodiment of the present disclosure; and

FIG. 7 is a schematic view illustrating a process of manufacturing a load part of a brake disk of a composite material according to an embodiment of the present disclosure.

### DETAILED DESCRIPTION

The technical terms used herein are to simply mention a particular exemplary embodiment and are not meant to limit the present disclosure. An expression used in the singular encompasses the expression of the plural, unless it has a clearly different meaning in the context. In the specification, it is to be understood that the terms such as “including” or “having” etc., are intended to indicate the existence of specific features, regions, numbers, stages, operations, elements, components, or combinations thereof disclosed in the specification, and are not intended to preclude the possibility that one or more other specific features, regions, numbers, operations, elements, components, or combinations thereof may exist or may be added.

Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted to have the meanings equal to the contextual meanings in the relevant field of art, and are not to be interpreted to have idealized or excessively formal meanings unless clearly defined in the present application.

Hereinafter, a brake disk of a composite material and a manufacturing method thereof according to embodiments of the present disclosure will be described with reference to the accompanying drawings.

First, a brake disk of a composite material according to the present disclosure will be described.

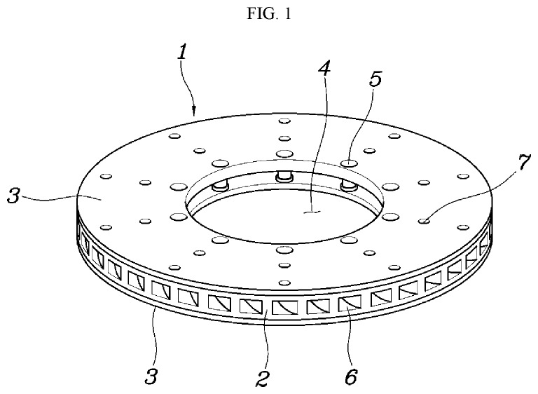

FIG. 1 illustrates an overall structure of a brake disk of a composite material. As illustrated in FIG. 1, the brake disk 1 of a composite material includes a load part 2 and a friction part 3. An axle hole 4, through which an axle shaft passes, is provided at a central portion of the brake disk 1 of a composite material. Through holes 5, through which bolts pass to be coupled with a hat part, are provided at the same circle at equal intervals. A cooling channel 6 is provided on a side surface of the brake disk 1 of a composite material. A cooling hole 7 communicating with the cooling channel 6 is provided on upper and lower surfaces of the brake disk 1 of a composite material.

The load part 2 absorbs an impact and outwardly dissipates frictional heat generated when the vehicle is braked. A thickness of the load part 2 is 20 to 50 mm, for example.

The friction part 3 is formed of carbon fibers and silicon carbide. The silicon carbide forms a matrix and the carbon fibers are randomly distributed in the matrix. The length of the carbon fibers is 150 to 200 μm. The friction part 3 is coupled to each of the upper and lower surfaces of the load part 2. A thickness of the friction part 3 is 2 mm or less. When the vehicle is braked, the friction part 3 directly comes into frictional contact with a pad (not shown), thus generating a frictional force necessary for braking.

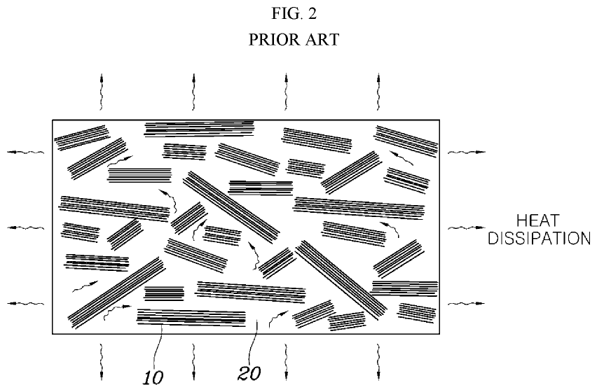

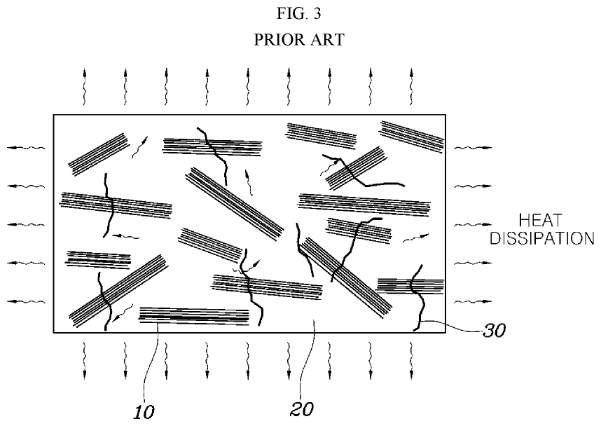

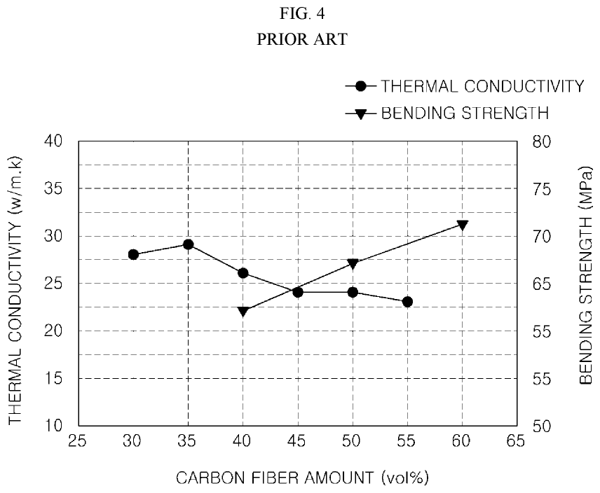

FIGS. 2 and 3 illustrate a structure of the related art brake disk of a composite material, and FIG. 4 is a graph illustrating thermal conductivity and bending strength changed according to fractions of carbon fibers in the structure of the load part of the related art brake disk of a composite material. The arrows illustrated in FIGS. 2 and 3 indicate a movement path of heat.

As illustrated in FIGS. 2 to 4, the related art load part includes the carbon fiber 10 and ceramics, i.e., the silicon carbide 20, and the carbon fibers 10 are randomly distributed inside the matrix of the silicon carbide 20. Conventionally, the fraction of the carbon fibers 10 is to be reduced to improve thermal conductivity. However, as the fraction of the carbon fibers 10 decreases, cracks 30 easily penetrate through the carbon fibers 10 to degrade bending strength, and thus, it is difficult to form a brake disk with high thermal conductivity and bending strength as well.

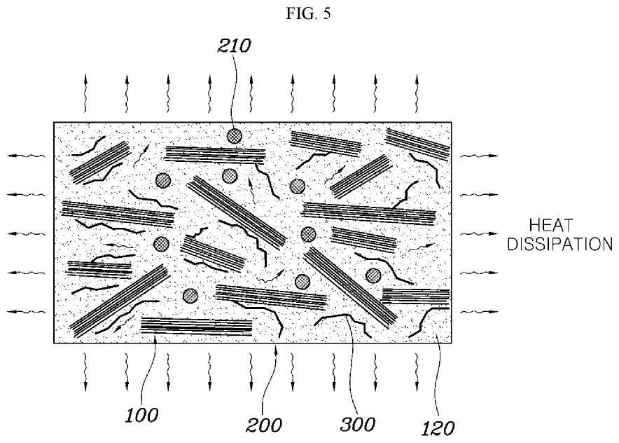

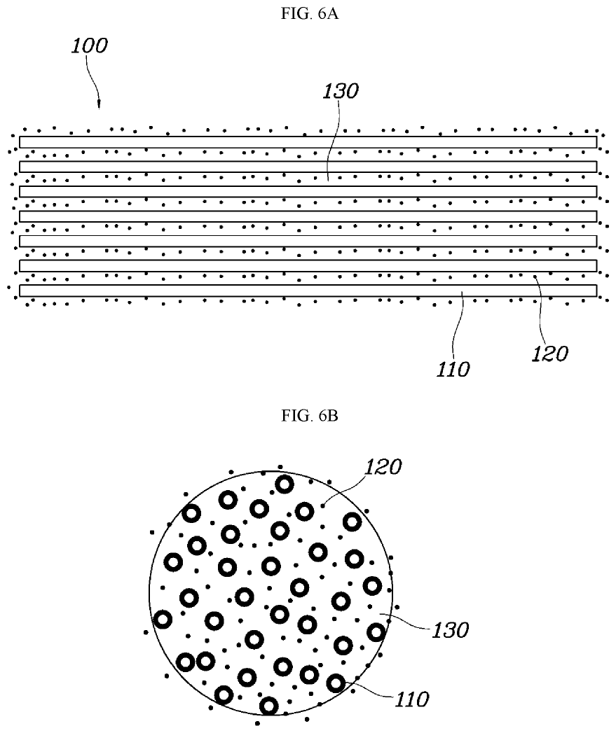

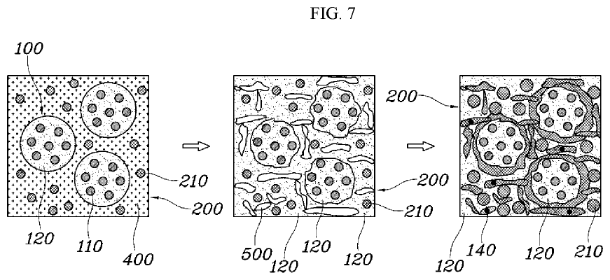

FIG. 5 illustrates a structure of a load part according to the present disclosure, FIGS. 6A and 6B illustrate a state of a carbon-carbon fiber (C-CF) according to the present disclosure, and FIG. 7 schematically illustrates a process of manufacturing a load part of a brake disk of a composite material according to an embodiment of the present disclosure.

As illustrated in FIGS. 5, 6A, 6B, and 7, the load part 2 of the present disclosure includes a reinforcing part 100 formed of carbon-carbon fiber (C-CF) material and a matrix part 200 including silicon carbide 210. Since the carbon-carbon fiber (C-CF), instead of the conventional carbon fiber, is applied, a crack 300 that occurs inside the load part 2 cannot grow to penetrate through the reinforcing part 100, and thus, bending strength may be formed at a high level although a fraction of the reinforcing part 100 is reduced.

Specifically, the reinforcing part 100 includes a plurality of carbon fiber filaments 110 and carbon particles 120 filling an empty space 130 between the carbon fiber filaments 110 and surrounding outer portions of the bundle of carbon fiber filaments 110. The number of the carbon fiber filaments 110 forming the reinforcing part 100 may be from thousands to hundreds of thousands.

The carbon particles 120 may be directly mixed with the carbon fiber filaments 110. More preferably, the carbon particles 120 may be provided from a resin by impregnating the carbon fiber filaments 110 with the resin and subsequently carbonizing the carbon fiber filament-impregnated resin.

The crack 300 occurring in the matrix part 200 of the load part 2 cannot penetrate through the carbon particles 120 surrounding the outer portions of the carbon fiber filaments 110, and cannot move toward the inside of the reinforcing part 100 due to the carbon particles 120 filling the empty space 130 between the plurality of carbon fiber filaments 110, if ever. As a result, the carbon fiber filaments 110 are not broken but maintained, and thus, high bending strength may be maintained.

A length of the reinforcing part 100 is 1 to 29 mm and a weight ratio of the reinforcing part 100 at the load part 2 must be equal to or less than a weight ratio of the matrix part 200. More preferably, the weight ratio of the reinforcing part 100 to the matrix part 200 is 0.4 to 1:1, and most preferably, 2:3. If the reinforcing part 100 is less than 40 parts by weight based on 100 parts by weight of the matrix part 200, bending strength may be excessively lowered and life expectancy of the entire brake disk may be lowered. If the reinforcing part 100 exceeds 100 parts by weight over the 100 parts by weight of the matrix part 200, the reinforcing part 100 may block a movement path of heat and sufficient heat conductivity and heat dissipation properties may not be obtained.

Next, a method for manufacturing a brake disk of a composite material according to the present disclosure will be described. The method for manufacturing a brake disk of a composite material according to the present disclosure includes a load part manufacturing operation of forming the load part 2 of a brake disk by successively performing a first impregnation process, a carbonization process, and a second impregnation process and a friction part manufacturing operation of forming friction parts 3 on opposing sides of the load part 2. In particular, the load part manufacturing operation is a characteristic part of the present disclosure.

As illustrated in FIG. 7, the first impregnation process is a process of impregnating the reinforcing part 100 including the carbon particles 120 and the carbon fiber filaments 110 with the resin 400 including power-type silicon carbide 210, the carbonization process is a process of heat-treating the resin impregnated in the first impregnation process to change the resin 400 into carbon particles 120, and the second impregnation process is a process of impregnating pores 500 formed during the carbonization process with silicon 140 to allow the same to react with the carbon particles 120 to form silicon carbide 210.

The resin 400 impregnated during the first impregnation process may be a thermosetting resin, preferably, a phenol resin. The reinforcing part 100, that is, the carbon-carbon fiber includes carbon particles 120 in the form of fine particles and the carbon fiber filaments 110. In this case, thousands to tens of thousands of carbon fiber filaments 110 gather to form a mass of the reinforcing part 100.

The carbonization process is a process of heat-treating the resin 400 impregnated during the first impregnation process at 900 to 1000° C. to change the carbon particles 120, which is performed to form additional carbon particles 120 in the matrix part 200 and form the silicon carbide 210 using the formed carbon particles 120. Here, as the resin 400 is changed into the carbon particles 120, a large amount of pores 500 are formed in the matrix part 200.

The second impregnation process is a process of impregnating the pores 500 formed during the carbonization process with silicon 140 which has been heated to 1300° C. or higher so as to be melted. During the process of impregnating the silicon 140, the silicon 140 may react with the carbon particles 120 present in the reinforcing part 100 and the matrix part 200 so as to be converted into the silicon carbide 210. Here, a partial amount of the silicon 140 which has not reacted with the carbon particles 120 may remain in the matrix part 200.

Preferably, the silicon 140 is heated to 1410° C. or higher so as to be melted and easily impregnated in the matrix part 200. Here, in order to heat silicon 140 at a high temperature, a large amount of energy is required. However, since the effect is insignificant, the temperature for heating the silicon 140 is preferably 1500° C. or lower.

Meanwhile, the matrix part 200 including the silicon carbide 210 may be formed by performing single carbonization process and single second impregnation process, but the fracture of the silicon carbide 210 in the matrix part 200 may be further increased by performing the carbonization process and the second impregnation process a plurality of times. By increasing the fracture of the silicon carbide 210 in the matrix part 200, thermal conductivity may be enhanced to increase heat capacity and reducing the weight.

The friction part manufacturing operation is an operation of manufacturing the friction part 3 of a composite material on opposing sides of the load part 2 after the above-described load part manufacturing step. The friction part 3 includes a silicon carbide matrix and randomly distributed carbon fibers therein. The operation of manufacturing the friction part 3 is similar to the load part manufacturing operation, and thus, a description thereof will be omitted here.

The brake disk of a composite material and the manufacturing method thereof according to the present disclosure have the following effects.

First, a brake disk having improved heat dissipation properties may be manufactured by enhancing thermal conductivity of the composite material.

Second, since the thermal conductivity of the composite material is improved without significantly changing the manufacturing process, application is simple.

Although the present disclosure has been shown and described with respect to specific embodiments, it will be apparent to those having ordinary skill in the art that the present disclosure may be variously modified and altered without departing from the spirit and scope of the present disclosure as defined by the following claims.

1. A brake disk of a composite material, the brake disk including a load part and friction parts coupled to opposing sides of the load part,
wherein the load part includes a reinforcing part formed of a carbon-carbon fiber (C-CF) material and a matrix part formed of a material including silicon carbide (SiC) and covering the reinforcing part, and
a weight ratio of the reinforcing part is equal to or lower than a weight ratio of the matrix part in the load part.

2. The brake disk of claim 1, wherein a weight ratio of the reinforcing part and the matrix part in the load part is 0.4 to 1:1.

3. The brake disk of claim 1, wherein the reinforcing part includes a plurality of carbon fiber filaments and carbon particles covering the carbon fiber filaments.

4. A method for manufacturing a brake disk of a composite material including a load part and friction parts coupled to opposing sides of the load part, the method comprising:
a load part manufacturing operation of including a first impregnation process to impregnate a reinforcing part formed of a carbon-carbon fiber (C-CF) material with a resin, a carbonization process of carbonizing the resin-impregnated reinforcing part, and a second impregnation process of impregnating melted silicon (Si) to form a matrix part including silicon carbide (SiC); and
a friction part manufacturing operation of forming the friction parts on opposing sides of the load part.

5. The method of claim 4, wherein during the carbonization process, the impregnated resin is heat-treated at 900 to 1000° C. to change the resin into carbon (C), and during the second impregnation process, pores formed as the resin is carbonized during the carbonization process is impregnated with silicon (Si) heated to 1300° C. or higher.

6. The method of claim 4, wherein during the first impregnation process, the reinforcing part is impregnated with a mixture of a resin and silicon carbide.

7. The method of claim 4, wherein during the load part manufacturing operation, after the first impregnation process is performed, the carbonization process and the second impregnation process are repeatedly performed a plurality of times to form a matrix part covering the reinforcing part.
